(19) United States
(12) Patent Application Publication
(10) Pub. No.: US 2025/0033358 A1
(43) Pub. Date: Jan. 30, 2025

(54) RECORDING APPARATUS AND CONTROL METHOD

(71) Applicant: CANON KABUSHIKI KAISHA, Tokyo (JP)

(72) Inventors: TETSUYA NARAZAKI, Kanagawa (JP); ATSUSHI TAKEI, Kanagawa (JP)

(21) Appl. No.: 18/783,133

(22) Filed: Jul. 24, 2024

(30) Foreign Application Priority Data
Jul. 25, 2023 (JP) 2023-121141

(51) Int. Cl. B41J 2/165; B41J 2/175; B41J 29/377

(52) U.S. Cl. CPC B41J 2/16511; B41J 2/17563; B41J 29/377; B41J 2002/16594; B41P 2235/27

(57) ABSTRACT

A recording apparatus includes a recording head including a tank configured to store ink, a liquid chamber connected to the tank, a filter arranged between the tank and the liquid chamber, and a discharge port configured to discharge ink supplied from the liquid chamber, a cap configured to cover the discharge port, and a suction pump configured to suction ink from the recording head via the cap, wherein the suction pump performs a first suction on the recording head, stops the first suction on the recording head, and then performs a second suction at a maximum drive speed that is higher than a drive speed at time of end of the first suction.

### FIELD OF THE DISCLOSURE

The present disclosure relates to a recording apparatus and a control method.

### DESCRIPTION OF THE RELATED ART

Inkjet recording apparatuses that include a recording head including a discharge port, a sub-tank, a liquid chamber channel (hereinafter referred to as a liquid chamber), and a filter, and an ink tank in which ink can be stored are known. The liquid chamber connects the discharge port to the sub-tank, and the filter is disposed between the sub-tank and the liquid chamber. As for such a recording apparatus, when ink inside the sub-tank runs out, the sub-tank needs to be replenished with ink from the ink tank, and the liquid chamber also needs to be filled with ink. When the liquid chamber is filled with ink, ink flows from the sub-tank. At the same time, the air flows from the sub-tank into the liquid chamber. Consequently, such air enters the discharge port at the time of discharge, causing a discharge failure.

U.S. Pat. No. 9,925,788 discusses a method for ejection of air inside a liquid chamber when a recording head is replenished with ink. According to the method, suction is performed in the liquid chamber, and suction with a maximum negative pressure is performed in a state in which ink is supplied to a sub-tank and the liquid chamber and a high negative pressure is no longer applied.

In the method discussed in U.S. Pat. No. 9,925,788, however, bubbles may be accumulated in a certain area. Once such a situation occurs, the bubbles in the area are unlikely to be ejected. Consequently, a large amount of ink needs to be consumed.

### SUMMARY

According to an aspect of the present disclosure, a recording apparatus includes a recording head including a tank configured to store ink, a liquid chamber connected to the tank, a filter arranged between the tank and the liquid chamber, and a discharge port configured to discharge ink supplied from the liquid chamber, a cap configured to cover the discharge port, and a suction pump configured to suction ink from the recording head via the cap, wherein the suction pump performs a first suction on the recording head, stops the first suction on the recording head, and then performs a second suction at a maximum drive speed that is higher than a drive speed at time of end of the first suction.

Further features of the present disclosure will become apparent from the following description of exemplary embodiments with reference to the attached drawings.

### BRIEF DESCRIPTION OF THE DRAWINGS

FIG. 1 is a perspective view illustrating an inkjet recording apparatus according to a first exemplary embodiment.

FIG. 2 is a diagram illustrating details of a supply mechanism according to the first exemplary embodiment.

FIG. 3 is a perspective view illustrating a recovery mechanism according to the first exemplary embodiment.

FIG. 4 is a diagram illustrating details of the recovery mechanism according to the first exemplary embodiment.

FIG. 5 is a schematic diagram illustrating a recording head according to the first exemplary embodiment.

FIG. 6 is a block diagram illustrating a control configuration according to the first exemplary embodiment.

FIG. 7 is a flowchart illustrating a suction procedure according to the first exemplary embodiment.

FIG. 8 is a table illustrating a suction parameter for system cleaning according to the first exemplary embodiment.

FIG. 9 is a schematic diagram illustrating a negative pressure profile of the system cleaning according to the first exemplary embodiment.

FIGS. 10A through 10F are schematic diagrams each illustrating an inside of a recording head during suction according to the first exemplary embodiment.

FIG. 11 is a table illustrating a suction parameter for system cleaning according to a second exemplary embodiment.

FIG. 12 is a schematic diagram illustrating a negative pressure profile of the system cleaning according to the second exemplary embodiment.

FIG. 13 is a flowchart illustrating a suction procedure according to a third exemplary embodiment.

FIG. 14 is a schematic diagram illustrating a negative pressure profile of the system cleaning according to the third exemplary embodiment.

FIG. 15 is a table illustrating a suction parameter for system cleaning according to a fourth exemplary embodiment.

FIG. 16 is a schematic diagram illustrating a negative pressure profile of the system cleaning according to the fourth exemplary embodiment.

### DESCRIPTION OF THE EMBODIMENTS

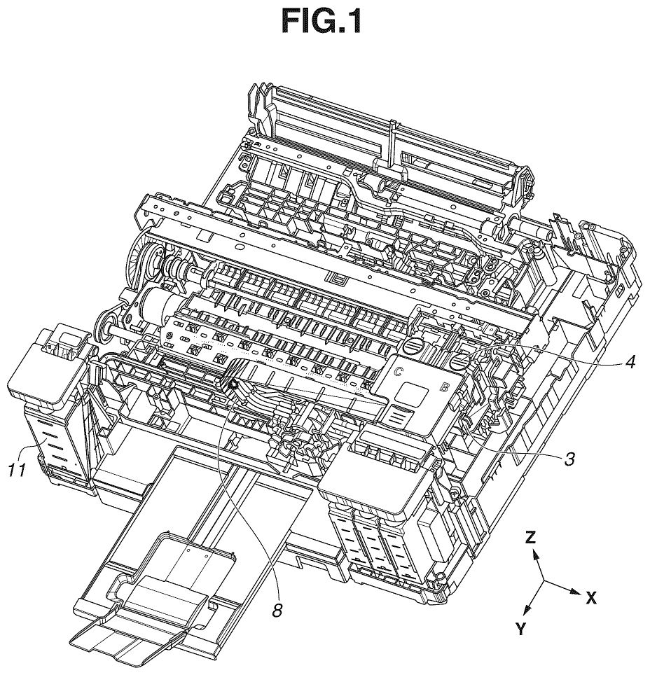

A first exemplary embodiment is to be described. FIG. 1 is a perspective view illustrating an inkjet recording apparatus (hereinafter also referred to as a recording apparatus) according to the present exemplary embodiment. A recording head 4 that discharges ink droplets is mounted on a carriage 3. The recording head 4 and a liquid container (a main tank) 11 in which ink is stored are connected by a supply tube 8, so that ink is supplied to the recording head 4. The recording head 4 can be directly connected to the liquid container 11.

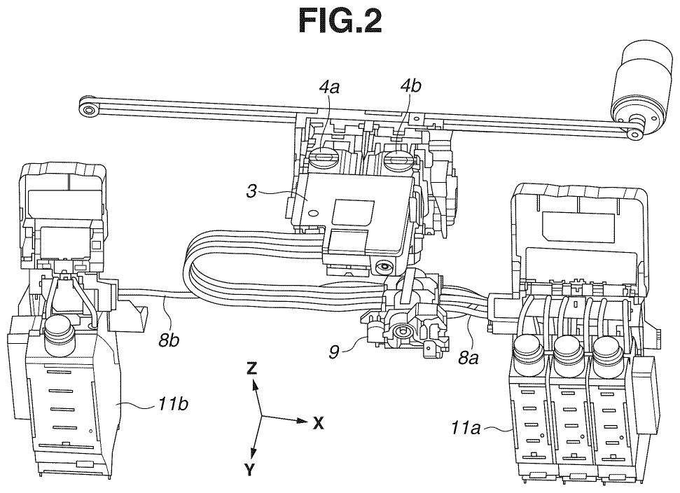

FIG. 2 is a diagram illustrating details of a supply mechanism according to the present exemplary embodiment. A liquid container 11a for color ink is connected to a recording head 4a via a supply tube 8a. A liquid container 11b for black ink is connected to a recording head 4b via a supply tube 8b. A tube valve 9 is manually moved, so that the supply tubes 8a and 8b can be closed.

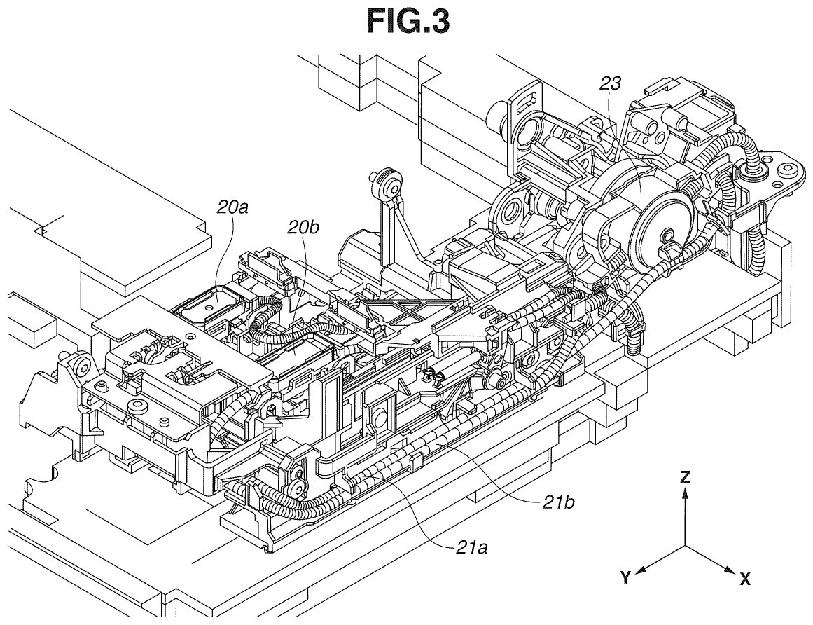

FIG. 3 is a perspective view illustrating a recovery mechanism according to the first exemplary embodiment. A cap 20 that covers a discharge port 7 of the recording head 4 is connected to a suction pump 23 via a suction tube 21.

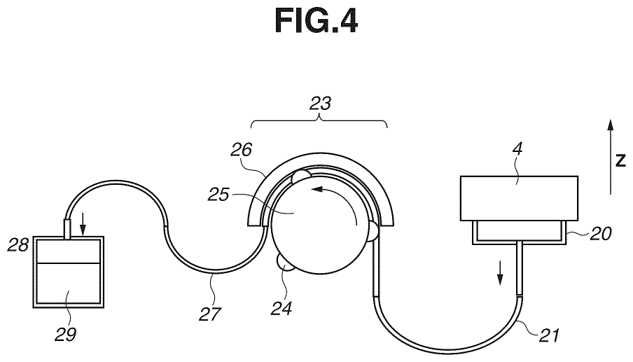

FIG. 4 is a diagram illustrating details of the recovery mechanism according to the present exemplary embodiment. The suction pump 23 is driven in a state in which the recording head 4 is sealed with the cap 20, so that ink is suctioned from the discharge port 7. In the suction pump 23, a shaft 25 on which a roller 24 is arranged is rotated in a direction indicated by an arrow illustrated in FIG. 4, so that a suction tube 21 in a portion held by the roller 24 and a guide 26 is successively squeezed, and rotation of the roller 24 depressurizes an inside of the tube. As a result, the recording head 4 is depressurized via the cap 20, and ink is suctioned from the discharge port 7. A suction amount is controlled based on the predetermined number of rotations or a predetermined rotation speed of the roller 24. The ink ejected from the suction pump 23 is stored in a waste ink tank 28 via a waste ink tube 27. The waste ink tank 28 includes a waste-ink absorbent member 29.

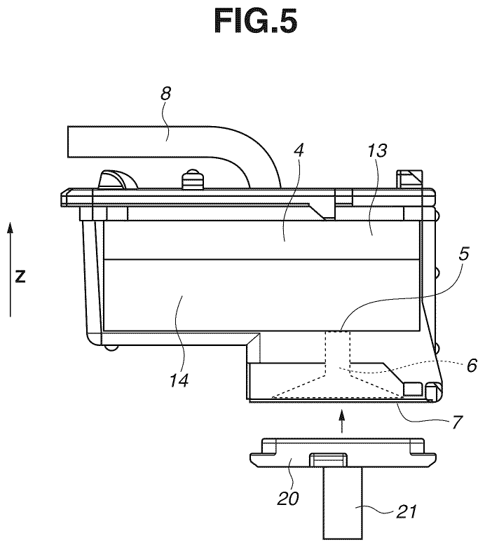

FIG. 5 is a schematic diagram illustrating the recording head 4 according to the present exemplary embodiment. The supply tube 8 is connected to a top portion of the recording head 4. A sub-tank 13 is disposed inside the recording head 4. The sub-tank 13 can include a porous absorbent member. A liquid chamber 6 is disposed below the sub-tank 13. A mesh filter 5 is arranged between the liquid chamber 6 and the sub-tank 13, and the discharge port 7 is arranged in a lower portion of the liquid chamber 6.

Bubbles are generated in an inner wall of the supply tube 8. Such bubbles gradually flow into the recording head 4 in a printing operation. When the bubbles gradually flow into the recording head 4, an amount of ink with which the sub-tank 13 has been filled is gradually decreased. Then, the ink inside the liquid chamber 6 runs out, causing a discharge failure. Such a case can be recovered by execution of system cleaning based on an instruction from a user so that the sub-tank 13 is filled with ink again.

The recording head 4 of the present exemplary embodiment is an inkjet recording head that discharges ink by using thermal energy and includes a plurality of electrothermal converters for generation of thermal energy. Particularly, the inkjet recording head generates thermal energy by using a pulse signal to be applied to the electrothermal converter, and causes film boiling to occur in ink liquid by the thermal energy. Then, the inkjet recording head uses bubbling pressure of the film boiling to discharge ink from a discharge port, thereby performing recording. Alternatively, a recording head that uses a piezoelectric transducer to discharge ink may be employed.

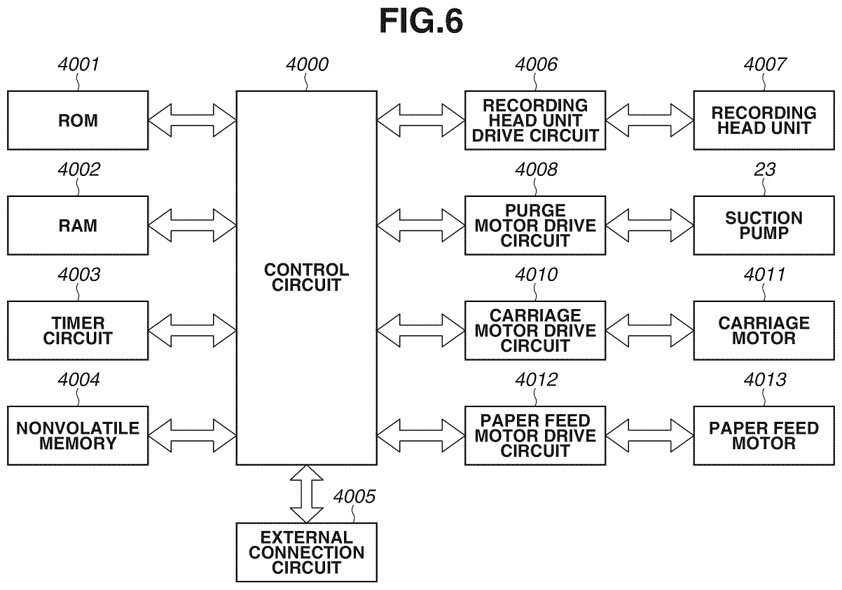

FIG. 6 is a block diagram illustrating a control configuration. A read only memory (ROM) 4001 stores a control program to be executed, and each setting value in a control operation. A random access memory (RAM) 4002 is a memory to which the aforementioned control program is loaded at the time of execution, and in which not only printing data and a control instruction are stored but also a control variable in each control operation is stored. A timer circuit 4003 is a circuit that can acquire the current time or can measure elapsed time. A nonvolatile memory 4004 is a memory unit that can store a parameter stored in a control operation even in a state in which a power supply of a recording apparatus main body is turned off. In a control operation in the present exemplary embodiment, a time as a starting point in calculation of elapsed time is written in or read out to the nonvolatile memory 4004. A control circuit 4000 executes the control program stored in the ROM 4001 or the control program loaded to the RAM 4002. A sequence in the present exemplary embodiment is one portion of a sequence that is executed based on the aforementioned control program.

An external connection circuit 4005 is a circuit that can be handled by the control circuit 4000. The external connection circuit 4005 is handled as a control signal and an interface when the inkjet recording apparatus main body and an external host apparatus communicate in a wired or wireless manner. Data of an image to be printed is input from an external unit via the external connection circuit 4005. The timer circuit 4003 can acquire the current time via the external connection circuit 4005.

The control circuit 4000 loads the received image data to the RAM 4002. Based on the data in the RAM 4002, the control circuit 4000 controls driving of a recording head unit 4007 via a recording head unit drive circuit 4006. At the same time, the control circuit 4000 controls a carriage motor 4011 via a carriage motor drive circuit 4010. Based on the control by the control circuit 4000, ink is discharged from a discharge port of the recording head unit 4007 while the recording head unit 4007 is moving in an X direction to execute one record-scanning by discharging ink to a desired position on a recording medium. Subsequently, the control circuit 4000 controls a paper feed motor 4013 via a paper feed motor drive circuit 4012 to convey the recording medium by a desired amount. The record-scanning and the conveyance of the recording medium are repeated, so that an image is recorded on the recording medium. A recording operation on a recording medium has been described as above.

In the suction recovery in the sequence according to the present exemplary embodiment, the control circuit 4000 controls the suction pump 23 via a purge motor drive circuit 4008 to suction a desired amount of ink from the recording head. In ink discharge to the cap, the control circuit 4000 controls driving of the recording head unit 4007 via the recording head unit drive circuit 4006 to eject a desired amount of ink. In this case, a pattern in which the recording head is driven is determined based on any of data loaded to the RAM 4002 or data in the ROM 4001 as similar to the aforementioned recording operation, or data generated by the control circuit 4000.

The inkjet recording apparatus executes a recovery operation (a cleaning operation) on a recording head based on suction recovery control. The recovery operation is designed to, for example, remove bubbles inside the recording head, eject ink solidified in the recording head, or fill the recording head with ink. Examples of situations in which the recovery operation is necessary include a situation that a cap is left open subsequent to abnormal termination, a situation that an ink tank is replaced, a situation that a certain time period has elapsed since the last recovery operation, and a situation that an amount of ink droplets (the number of dots) that have been used in a recording operation since execution of the last recovery operation exceeds a certain value or more. In such a situation in which the recovery operation is necessary, a recovery flag is set, and the set recovery flag is stored in the nonvolatile memory 4004 illustrated in FIG. 6. The recovery operation is executed at a prescribed time based on the recovery flag.

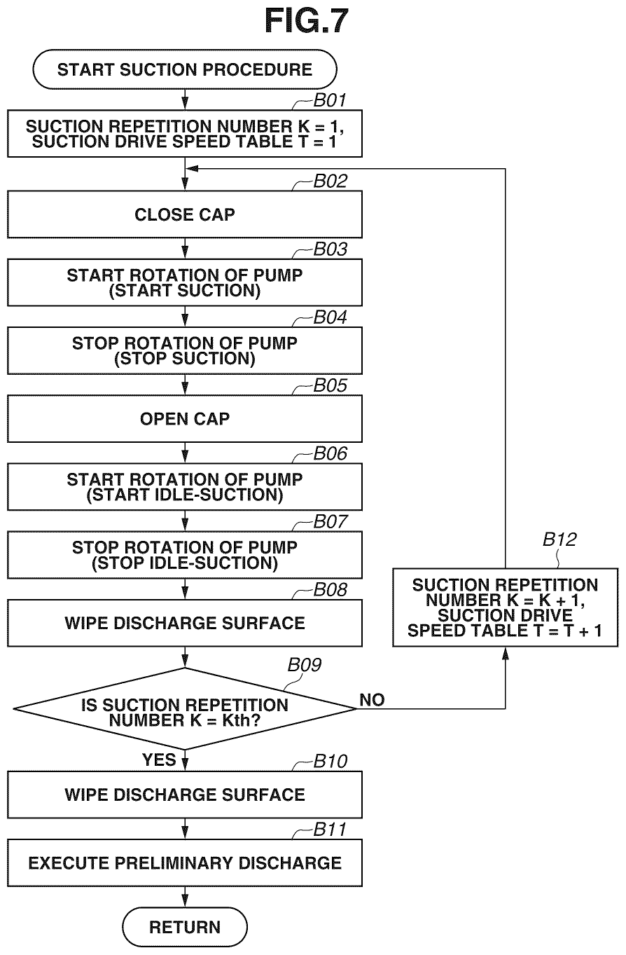

FIG. 7 is a flowchart illustrating a suction procedure after a recovery operation is started according to the first exemplary embodiment. The control circuit 4000 executes the processing of the flowchart illustrated in FIG. 7 based on the control program stored in the ROM 4001.

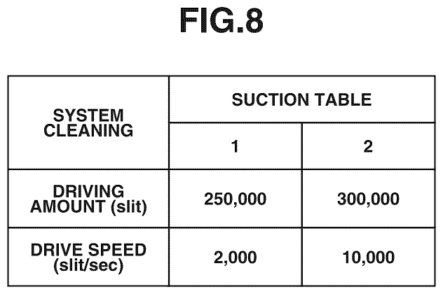

When a suction procedure is started, in step B01, the control circuit 4000 sets a suction repetition number to K=1 and sets a suction drive speed table (hereinafter referred to as a suction table) to T=1 in the RAM 4002. The suction table is described with reference to FIG. 8. In step B02, the control circuit 4000 closes the cap 20 by using the carriage motor drive circuit 4010, and the cap 20 is pushed toward the recording head 4 and closely contacts a discharge port surface.

In step B03, the control circuit 4000 starts rotation of a pump by using the purge motor drive circuit 4008, and also starts suction. After the predetermined number of rotations is made, the processing proceeds to step B04. In step B04, the control circuit 4000 stops the rotation of the pump by using the purge motor drive circuit 4008, and finishes the suction.

In step B05, the control circuit 4000 opens the cap 20 by using the carriage motor drive circuit 4010 to separate the cap 20 from the recording head 4, so that the inside of the recording head 4 is exposed to the atmospheric pressure. Herein, either the cap 20 or the recording head 4 can be moved, or both of the cap 20 and the recording head 4 can be moved. A method for exposure to the atmospheric pressure is not limited to the opening of the cap 20. For example, the inside of the cap 20 may be configured to have atmospheric pressure with the cap 20 covering the recording head 4.

In step B06, the control circuit 4000 rotates the pump again to idle-suction ink remaining inside the cap 20 and ejects the resultant ink. After the predetermined number of rotations is made, the processing proceeds to step B07. In step B07, the control circuit 4000 stops the rotation of the pump, and stops the idle suction. Subsequently, in step B08, the control circuit 4000 wipes a discharge surface by using the carriage motor drive circuit 4010.

In step B09, the control circuit 4000 determines whether the suction repetition number K is equal to a threshold value Kth. If the control circuit 4000 determines that the suction repetition number K is equal to the threshold value Kth (YES in step B09), the control circuit 4000 finishes the suction, and the processing proceeds to step B10. If the control circuit 4000 determines that the suction repetition number K is not equal to the threshold value Kth (NO in step B09), the processing proceeds to step B12. In step B12, the control circuit 4000 increments the suction repetition number K and the suction table T. Then, the processing returns to step B02 in which suction is repeated. In the present exemplary embodiment, Kth=2.

In step B10, the control circuit 4000 wipes the discharge surface, and the processing proceeds to step B11. In step B11, the control circuit 4000 executes preliminary discharge by using the recording head unit drive circuit 4006, and the processing ends. The preliminary discharge is discharge of ink not based on image data transmitted to the recording apparatus by a user, and is performed to maintain or recover a discharge state. The preliminary discharge is performed by discharging ink to the inside of the cap 20 or a platen that supports a recording medium.

In the present exemplary embodiment, the cap 20 is separated from the recording head 4 to perform exposure to the atmospheric pressure. However, an air release valve disposed in the cap may be opened.

FIG. 8 is a table illustrating a suction parameter for system cleaning (in steps B03 to B04 illustrated in FIG. 7) according to the first exemplary embodiment. In the system cleaning, the suction table 1 includes a driving amount of 250,000. In the system cleaning, the suction table 2 includes a driving amount of 300,000 Moreover, the suction table 1 includes a drive speed of 2,000, and the suction table 2 includes a drive speed of 10,000. Accordingly, suction based on the suction table 2 is performed at a higher drive speed than that based on the suction table 1. Herein, the speed in the suction table 1 is a certain speed that causes a meniscus to not be torn in a filter, and the speed in the suction table 2 is higher than a flow speed that is generated by printing by discharge of ink. In execution of step B03 of the flowchart illustrated in FIG. 7 for the first time (suction table T=1), suction is performed based on the suction table 1 (hereinafter also referred to as first suction). In execution of step B03 for the second time (suction table T=2), suction is performed based on the suction table 2 (hereinafter also referred to as second suction).

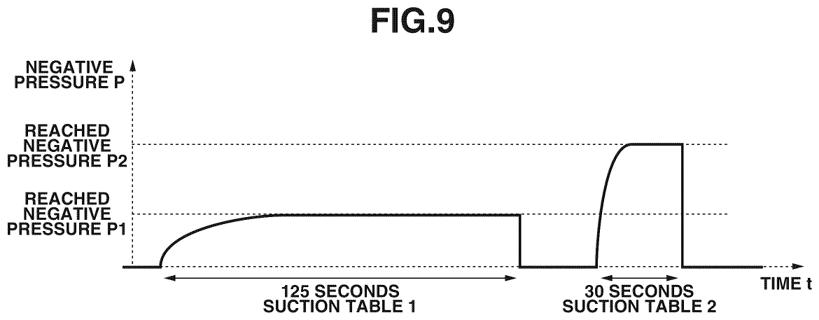

FIG. 9 is a schematic diagram illustrating a negative-pressure profile of the system cleaning according to the first exemplary embodiment. A negative pressure of the cap in the system cleaning provides a negative-pressure waveform having two peaks. Since the first suction and the second suction differ in drive speed, the first suction provides a maximum reached negative pressure P1, and the second suction provides a maximum reached negative pressure P2. A maximum drive speed (herein P2) in the second suction is higher than a drive speed (herein P1) at the end of the first suction.

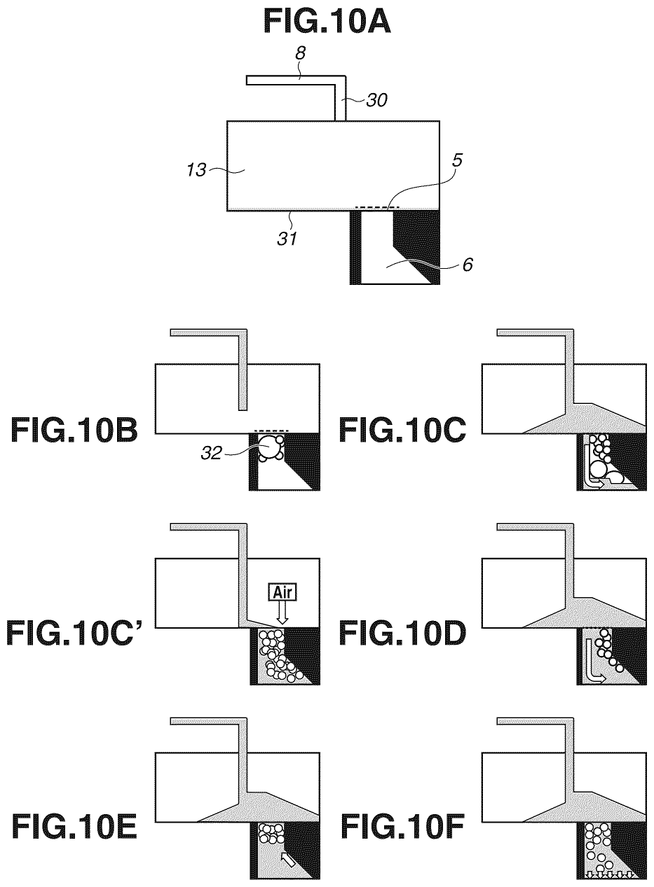

FIGS. 10A through 10F are schematic diagrams each illustrating an inside of the recording head 4 during suction.

FIG. 10A illustrates a state in which K=1 in step B01 of FIG. 7. The sub-tank 13 is not completely empty of ink, and has remaining ink 31. In FIG. 10B, ink is supplied from the liquid container 11 as a main tank to an inlet of the sub-tank 13 by suction (K=1 and T=1 in step B03 of FIG. 7). Herein, both of air and ink pass through the filter 5 at first by the remaining ink 31, and many bubbles are generated. Subsequently, as illustrated in FIG. 10C, suction is performed (K=1 and T=1 in step B03 of FIG. 7) at a speed at which ink supplied from the liquid container 11 into the sub-tank 13 does not tear a meniscus in the filter 5, thereby preventing generation of new bubbles. Herein, if suction is not performed at a low speed, as illustrated in FIG. 10C′, a meniscus in the filter 5 is torn and the air inside the sub-tank 13 is suctioned at the same time, causing generation of many bubbles. FIG. 10D illustrates a state in which time has elapsed since the state illustrated in FIG. 10C. If a drive speed is increased from the state illustrated in FIG. 10D without exposure to the atmosphere, and suction with K=2 and T=2 is performed, a flow field that has been generated in the state FIG. 10D is not markedly changed. Consequently, since a force is unlikely to be applied to bubbles that have been present in a low-flow-speed area and such bubbles are unlikely to be removed, a driving amount needs to be increased to perform suction. The driving amount is proportional to a suction amount, and an increase in the driving amount causes an increase in waste ink amount.

FIG. 10E illustrates behavior of bubbles when exposure to the atmosphere (step B04 of FIG. 7) is performed subsequent to the state illustrated in FIG. 10D, and an advantage of the present exemplary embodiment is described herein. The exposure to the atmosphere initializes the flow field, and bubbles are gathered in an area near the filter 5. FIG. 10F illustrates a subsequent state, that is, movement of the bubbles when suction with K=2 and T=2 at a higher drive speed is performed. Herein, since the flow field has been once initialized, a force is evenly applied when the suction with K=2 and T=2 is performed, and bubbles are likely to be removed. The flow field herein is similar to that when discharge is performed in actual printing. Thus, even if some bubbles are not ejected and remain herein, a printing failure can be prevented as long as a speed of suction with K=2 and T=2 is enough with respect to a speed in the flow field at the time of recording.

Therefore, after the first suction is performed, a flow field is once initialized and the second suction is performed. Thus, bubbles can be efficiently ejected, so that an ink consumption amount at the time of filling of the recording head with ink can be reduced.

A second exemplary embodiment is to be described. In the first exemplary embodiment, suction with K=1 and T=1 and suction with K=2 and T=2 are only performed. The suction with K=2 and T=2 is performed at a drive speed that is higher than that in the suction with K=1 and T=1. However, the present exemplary embodiment is not limited to the two types of suction. Herein, the suction table speed T in the first exemplary embodiment is set to Ta. Configurations that differ from those in the first exemplary embodiment are mainly described.

In a case where a supply channel (a supply tube 8 in the present exemplary embodiment) that connects a liquid container 11 to a sub-tank 13 is not filled with ink (in a state illustrated in FIG. 10A), ink may be moved from the liquid container 11 to a recording head 4 by suction that is performed at a drive speed higher than first suction. Even in such a case, bubbles are not generated in a filter 5 since ink is not present in an area near the filter 5.

In the present exemplary embodiment, the suction procedure illustrated in FIG. 7 is also performed. Configurations that differ from those in the first exemplary embodiment are described.

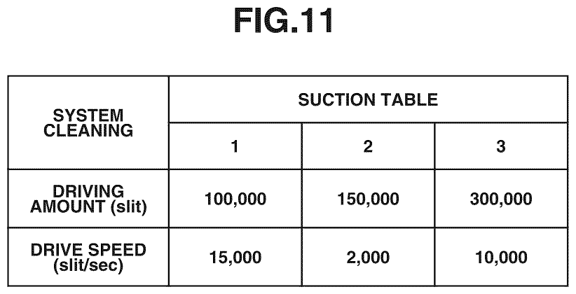

FIG. 11 is a table illustrating a suction parameter for system cleaning (steps B03 to B04 in FIG. 7) according to the second exemplary embodiment. When ink is suctioned to the sub-tank 13 from the liquid container 11 before the filter 5 is filled with ink, suction (third suction) is performed using a suction table 1. Herein, suction can be performed at a speed Tβ that is a higher speed than suction with Tα=1 in the first exemplary embodiment. Herein, Tβ=1 can be Tβ=3 or higher or Tβ=3 or lower.

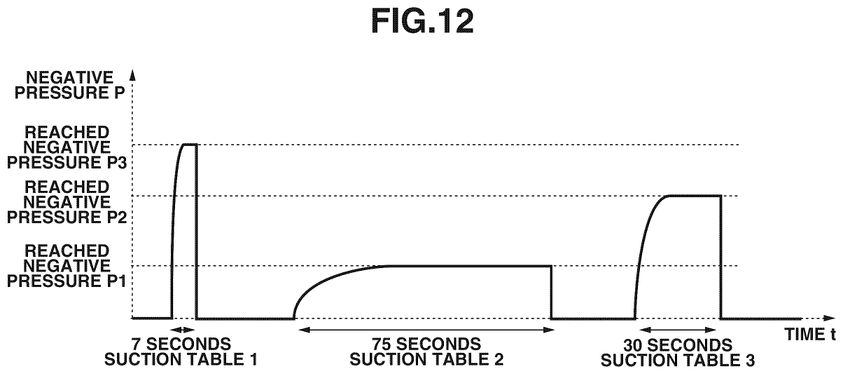

FIG. 12 is a schematic diagram illustrating a negative-pressure profile when suction is performed using a suction parameter illustrated in FIG. 11. Accordingly, when bubbles are not generated, high-speed suction can reduce an amount of suction time.

A third exemplary embodiment is to be described. In the second exemplary embodiment, exposure to the atmosphere is performed between suction based on the suction table 1 by which a supply channel is filled with ink and suction based on the suction table 2 by which the filter 5 is filled with ink. However, exposure to the atmosphere is not necessarily performed. Although exposure to the atmosphere is performed between suction based on the suction table 2 and suction based on a suction table 3 to initialize a bubble state, a volume of bubbles that have been generated between the suction based on the suction table 1 and the suction based on the suction table 2 is not large, and the subsequent suction based on the suction table 2 is not intended to eject the bubbles. Configurations that differ from those in the above-described exemplary embodiments are mainly described.

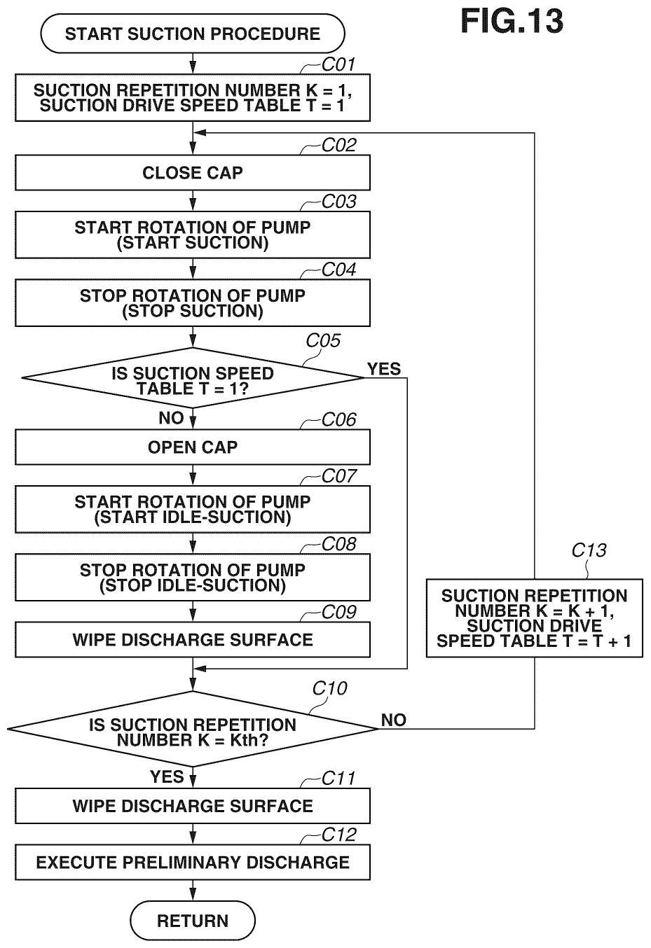

FIG. 13 is a flowchart illustrating a suction procedure when exposure to the atmosphere is not performed between suction based on the suction table 1 illustrated in FIG. 11 and suction based on the suction table 2 illustrated in FIG. 11. Processing in steps C01 through C04 illustrated in FIG. 13 is substantially the same as that in step B01 through B04 illustrated in FIG. 11. Processing in steps C06 through C13 illustrated in FIG. 13 is substantially the same as that in step B05 through B12 illustrated in FIG. 11.

In step C05, a control circuit 4000 determines whether a suction table is 1 (T=1). If the control circuit 4000 determines that the suction table is 1 (YES in step C05), the processing proceeds to step C10 without exposure to the atmosphere by opening of a cap.

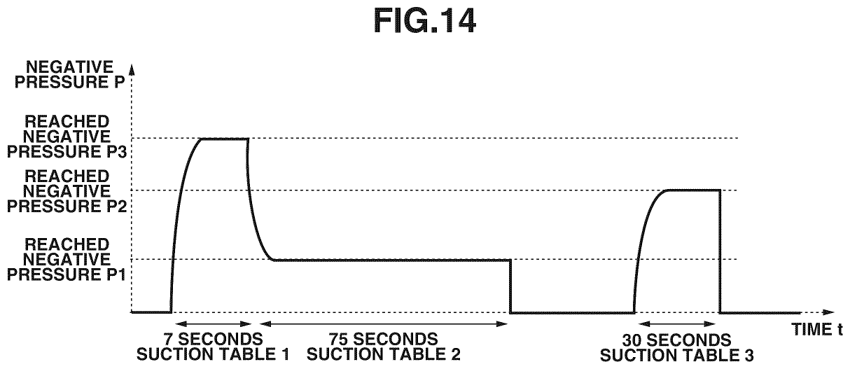

FIG. 14 is a schematic diagram illustrating a negative-pressure profile when suction in the flowchart of FIG. 13 is performed using the suction parameter illustrated in FIG. 11. The exposure to the atmosphere is not performed between suctions, so that suction time is shorter than that in the second exemplary embodiment. Moreover, since suction during which a negative pressure is increased is no longer performed, waste ink can be reduced.

A fourth exemplary embodiment is to be described. In the first exemplary embodiment, suction at a second drive speed is performed only once. However, the suction at the second drive speed may be performed multiple times. Configurations that differ from those in the above-described exemplary embodiments are mainly described.

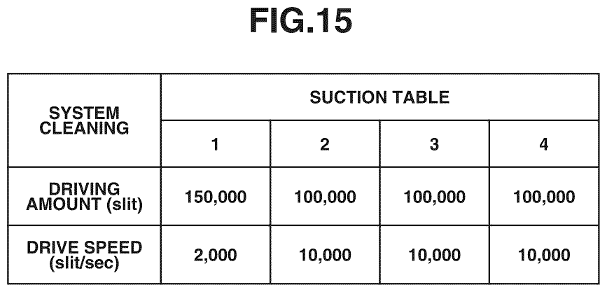

FIG. 15 is a table illustrating a suction parameter for system cleaning according to the fourth exemplary embodiment. The suction at the second drive speed is divided into three segments. The number of times that suction is divided herein is optional.

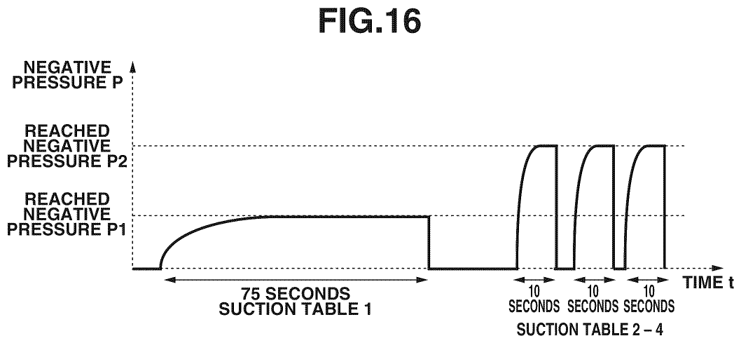

FIG. 16 is a schematic diagram illustrating a negative-pressure profile when suction is performed using the suction parameter illustrated in FIG. 15.

Prior to the suction at the second drive speed, exposure to the atmosphere is performed to initialize a state of bubbles inside. Even if the bubble state is initialized once, continuation of suction causes an area in which an ink flow speed is low and an area in which bubbles are caught to be generated inside a liquid chamber 6 as similar to the above. Thus, suction to be performed at the second drive speed is divided so that exposure to the atmosphere is performed between the divided suctions. Accordingly, an initialized state is created multiple times, thereby facilitating removal of bubbles.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-121141, filed Jul. 25, 2023, which is hereby incorporated by reference herein in its entirety.

What is claimed is:

1. A recording apparatus comprising:
a recording head including a tank configured to store ink, a liquid chamber connected to the tank, a filter arranged between the tank and the liquid chamber, and a discharge port configured to discharge ink supplied from the liquid chamber;
a cap configured to cover the discharge port; and
a suction pump configured to suction ink from the recording head via the cap,
wherein the suction pump performs a first suction on the recording head, stops the first suction on the recording head, and then performs a second suction at a maximum drive speed that is higher than a drive speed at time of end of the first suction.

2. The recording apparatus according to claim 1, wherein the discharge port is exposed to atmosphere to stop suction on the recording head.

3. The recording apparatus according to claim 1, wherein the tank includes an absorbent member.

4. The recording apparatus according to claim 1, further comprising:
a liquid container configured to store ink; and
a tube configured to connect the liquid container to the recording head,
wherein ink is supplied from the liquid container to the recording head via the tube.

5. The recording apparatus according to claim 1, wherein, in the second suction, suction on the recording head by the suction pump and stoppage of the suction are performed a plurality of times.

6. The recording apparatus according to claim 1, wherein the second suction takes shorter time than the first suction.

7. The recording apparatus according to claim 1, wherein before the first suction is performed, a third suction is performed at a maximum drive speed that is higher than a speed at time of end of the first suction.

8. The recording apparatus according to claim 7, wherein suction on the recording head is stopped between the third suction and the first suction.

9. The recording apparatus according to claim 8, wherein the discharge port is exposed to atmosphere to stop suction on the recording head.

10. The recording apparatus according to claim 7, wherein the second suction takes longer time than the third suction.

11. The recording apparatus according to claim 7, wherein the third suction takes longer time than first suction.

12. The recording apparatus according to claim 2, wherein the cap is separated from the recording head to perform the exposure to atmosphere.

13. A control method for a recording apparatus that includes a recording head including a tank configured to store ink, a liquid chamber connected to the tank, a filter arranged between the tank and the liquid chamber, and a discharge port configured to discharge ink supplied from the liquid chamber, a cap configured to cover the discharge port, and a suction pump configured to suction ink from the recording head via the cap, the control method comprising:
causing the suction pump to perform a first suction on the recording head;
causing the suction pump to stop suction on the recording head after performing the first suction; and
causing the suction pump to perform a second suction at a maximum drive speed that is higher than a drive speed at time of end of the first suction.
